(19) United States
(12) Patent Application Publication
(10) Pub. No.: US 2023/0289597 A1
(43) Pub. Date: Sep. 14, 2023

(54) METHOD AND A SYSTEM FOR GENERATING SECONDARY TASKS FOR NEURAL NETWORKS

(71) Applicant: HITACHI, LTD., Tokyo (JP)

(72) Inventors: Manikandan R, Bangalore (IN); Yuichi Nonaka, Tokyo (JP); Kingshuk Banerjee, Bangalore (IN); Shibashish Sen, Bangalore (IN)

(73) Assignee: HITACHI, LTD., Tokyo (JP)

(21) Appl. No.: 18/170,632

(22) Filed: Feb. 17, 2023

(30) Foreign Application Priority Data
Mar. 11, 2022 (IN) 202241013379

(51) Int. Cl. G06N 3/08

(52) U.S. Cl. CPC G06N 3/08

(57) ABSTRACT

The present disclosure relates to a method and a system for generating secondary tasks for neural networks. The method comprises receiving a feature set related to each of multiple data items, which are generated for a primary task. Further, the method comprises determining an association score between each of the features of a data item with each of the features of other data items. Furthermore, the method comprises identifying a first set of features by comparing the association score with a threshold value. The association score must be greater than the threshold value for the features to be included in the first set of features. Moreover, the method comprises identifying secondary features by mapping the first set of features with the feature set. Thereafter, the method comprises generating secondary tasks based on the secondary features for a neural network.

### TECHNICAL FIELD

The present disclosure generally relates to the field of artificial intelligence and data analytics. More particularly, the present disclosure relates to a method and a system for generating secondary tasks for neural networks.

### BACKGROUND

Neural networks are computational models, which try to mimic the way human brain makes decisions. Neural networks are widely used in diverse real-time applications in different industries. Such neural networks when used in the real-time applications needs ability to deal with multiple tasks. For example, the neural networks when implemented in video analytics systems, such as surveillance applications for identifying pedestrians, need to solve tasks such as identifying attributes of a pedestrian, identifying the pedestrian, and the like. In another example, the neural networks when implemented in vehicle identification systems solves tasks such as identifying a vehicle, vehicle brand recognition, number plate identification, and the like. In another example, the neural networks may be used in crowd monitoring to recognize people, count number of people in a specific area, monitor people violating rules, and the like. However, applications may lack data and annotation, resulting in increased time for data collection, cleaning, annotation, model development, and the like. As a result, developing the neural networks for different tasks is costly and cumbersome. In certain applications such as video analytics, and videos including multiple objects such as people, vehicle, and the like may be provided to the neural networks. There may be a requirement to use neural networks to perform multiple tasks related to the objects. Thus, scale of the solution may change based on multiple requirements and with addition of different kinds of objects. In such cases, the training of the neural networks becomes repetitive and expensive.

Conventional techniques such as semi-supervised learning, zero-shot learning, few shot learning, and the like tackle the need of large data and annotation. However, these techniques do not provide solutions to scale the neural networks to deal with multiple tasks without minimalistic annotation. Some other conventional techniques utilize image views extraction to tackle one or more newer tasks. Each image view represents a different task to the neural network. However, these conventional techniques are not well equipped to automatically create different tasks from the given data.

The information disclosed in this background section is only for providing a better understanding of the general background of the invention and should not be taken as an acknowledgement or any form of suggestion that it forms the prior art already known to a person skilled in the art.

### SUMMARY

In an embodiment, the present disclosure discloses a method for generating secondary tasks for neural networks. The method comprises receiving a feature set comprising one or more features of each of a plurality of data items. The one or more features are generated for a primary task. Further, the method comprises determining an association score between each of the one or more features of a data item from the plurality of data items with each of the one or more features of other data items from the plurality of data items. Furthermore, the method comprises identifying a first set of features from the feature set based on a comparison of the association score related to the one or more features of the plurality of data items with a threshold value. The association score must be greater than the threshold value for the features to be included in the first set of features. Moreover, the method comprises identifying one or more secondary features by mapping the first set of features with the feature set. Thereafter, the method comprises generating one or more secondary tasks based on the one or more secondary features for a neural network.

In an embodiment, the present disclosure discloses a task generation system for generating secondary tasks for neural networks. The task generation system comprises one or more processors and a memory. The one or more processors are configured to receive a feature set comprising one or more features of each of a plurality of data items. The one or more features are generated for a primary task. Further, the one or more processors are configured to determine an association score between each of the one or more features of a data item from the plurality of data items with each of the one or more features of other data items from the plurality of data items. Furthermore, the one or more processors are configured to identify a first set of features from the feature set based on a comparison of the association score related to the one or more features of the plurality of data items with a threshold value. The association score must be greater than the threshold value for the features to be included in the first set of features. Moreover, the one or more processors are configured to identify one or more secondary features by mapping the first set of features with the feature set. Thereafter, the one or more processors are configured to generate one or more secondary tasks based on the one or more secondary features for a neural network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment for generating secondary tasks for neural networks, in accordance with some embodiments of the present disclosure;

FIG. 2 illustrates a detailed diagram of a task generation system for generating secondary tasks for neural networks, in accordance with some embodiments of the present disclosure;

FIG. 3 shows an exemplary flow chart illustrating method steps for generating secondary tasks for neural networks, in accordance with some embodiments of the present disclosure;

FIGS. 4, 5A, and 5B show exemplary illustrations for secondary tasks for generating neural networks, in accordance with some embodiments of the present disclosure; and

FIG. 6 shows a block diagram of a general-purpose computing system for generating secondary tasks for neural networks, in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and a task generation system for generating secondary tasks for neural networks. The neural networks may be used in different applications to solve some tasks. The tasks may be generated using a plurality of data items related to the different applications. In the present disclosure, firstly, a feature set related to the plurality of data items is received. The feature set may be generated by a neural network for a primary task. The task generation system determines an association score between one or more features of the plurality of data items. Further, the task generation system identifies a first set of features from the feature set, by comparing the association score with a threshold value. The first set of features are identified such that associations between the features is high. These associations are used to generate one or more secondary features. One or more secondary tasks are generated based on the one or more secondary features. The one or more secondary tasks are provided for training a neural network or for scaling trained neural networks. Hence, the present disclosure aids in generating multiple secondary tasks from a primary task for the neural network. The secondary tasks can be used for training an untrained neural network or for scaling a trained neural network for multiple new tasks. Hence, the neural network can be used to perform diverse tasks and can be scaled across multiple domains.

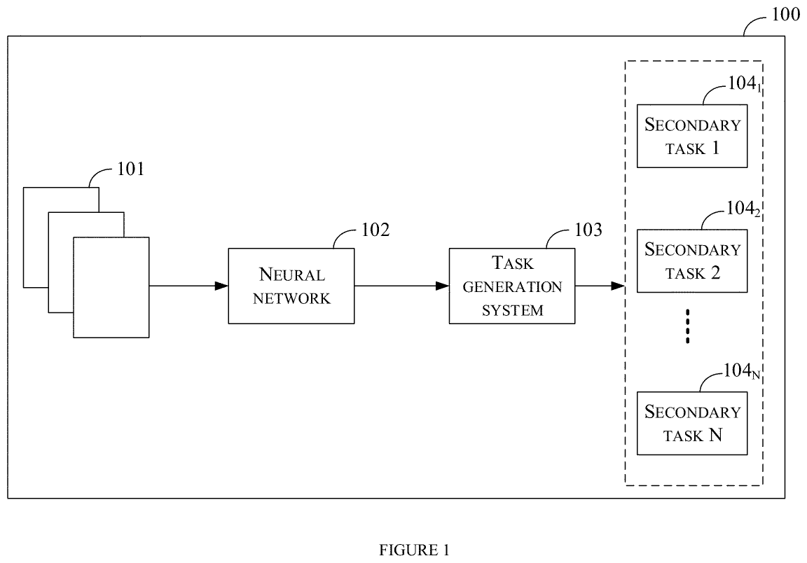

FIG. 1 illustrates an exemplary environment 100 for generating secondary tasks for neural networks, in accordance with some embodiments of the present disclosure. The environment 100 comprises a neural network 102 and a task generation system 103. The neural network 102 may be provided with a plurality of data items 101 associated with applications in which the neural networks 102 are implemented. The plurality of data items 101 comprises one of, images, videos, audio inputs, text inputs, speech inputs, and the like. The plurality of data items 101 may be received from sources such as, databases, capturing units, voice recorder, and the like. The neural network 102 uses the plurality of data items 101 and provides results by developing patterns from the plurality of data items 101 in real-time applications. For example, the neural network 102 may be implemented in the applications of video analytics such as object detection, object tracking, facial recognition, and the like. In the above-stated example, the video analytics may be for surveillance. In such case, the plurality of data items 101 may comprise a plurality of images of scenes in a place. The plurality of images may be a sequence of images comprising pedestrians, vehicles, and like in the place. The neural network 102 may be used to monitor the vehicles in order to determine the number of people violating traffic rules. The neural network 102 which is also known as an artificial neural network, is a computing system with interconnected nodes. The neural network 102 recognizes hidden patterns and correlations in the plurality of data items 101, and subsequently it clusters and classifies them over time for continuous learning and improvement. The neural network 102 comprises at least one of a Convolution Neural Network (CNN), a Recurrent Neural Network (RNN), a Long Short-term Memory (LSTM), a recursive neural network, a graph convolutional network, a sequential neural network, an encoder-decoder network, a combination thereof, and the like. A person skilled in the art will appreciate that the present disclosure is applicable to any neural networks other than the above-mentioned neural networks. The neural network 102 may be trained for a task by providing the plurality of data items 101.

The present disclosure generates secondary tasks for the neural network 102 based on a primary task. The primary task may be a task for which the neural network 102 is pre-trained or trained by providing user inputs. The task generation system 103 is implemented for generating the secondary tasks for the neural network 102. In one embodiment, the neural network 102 can be implemented within the task generation system 103. In other embodiment, the neural network 102 can be implemented within other systems. The task generation system 103 may transmit the generated secondary tasks to the other systems. Firstly, the task generation system 103 receives a feature set comprising one or more features of each of the plurality of data items 101. The one or more features may be provided by the neural network 102. The neural network 102 providing the one or more features may be associated with the task generation system 103 or any other systems. In an embodiment, the neural network 102 may be trained for the primary task and hence may have the ability to extract the one or more features. In another embodiment, a user may provide data related to the primary task to the neural network 102 to train it for the primary task. The task generation system 103 may determine an association score between each of the one or more features of a data item from the plurality of data items 101 with each of the one or more features of other data items from the plurality of data items 101. Associations between the one or more features are determined to derive new features for generating the secondary tasks. Then, the task generation system 103 identifies a first set of features from the feature set having the association score greater than a threshold value. The threshold value indicates a level of association or correlation between the one or more features. The threshold value may be pre-defined or dynamically updated. The first set of features are mapped to the feature set to identify one or more secondary features. The one or more secondary features are labelled to generate one or more secondary tasks 104₁, 104₂, . . . , 104_{N} (collectively referred as the one or more secondary tasks 104 in the present description) for the neural network 102. Further, the task generation system 103 identifies a second set of features from the feature set having an association score below the threshold value. The task generation system 103 performs further processing on the second set of features to generate the one or more secondary tasks 104 for the neural network 102. The neural network 102 provided with the one or more secondary tasks 104 may be a trained neural network or an untrained neural network. In an example, the neural network 102 used for extracting the feature set may be different than a neural network 102 for which the one or more secondary tasks 104 are provided. In the present description, the term neural network 102 is used throughout only for explanation purposes and should not be considered limiting.

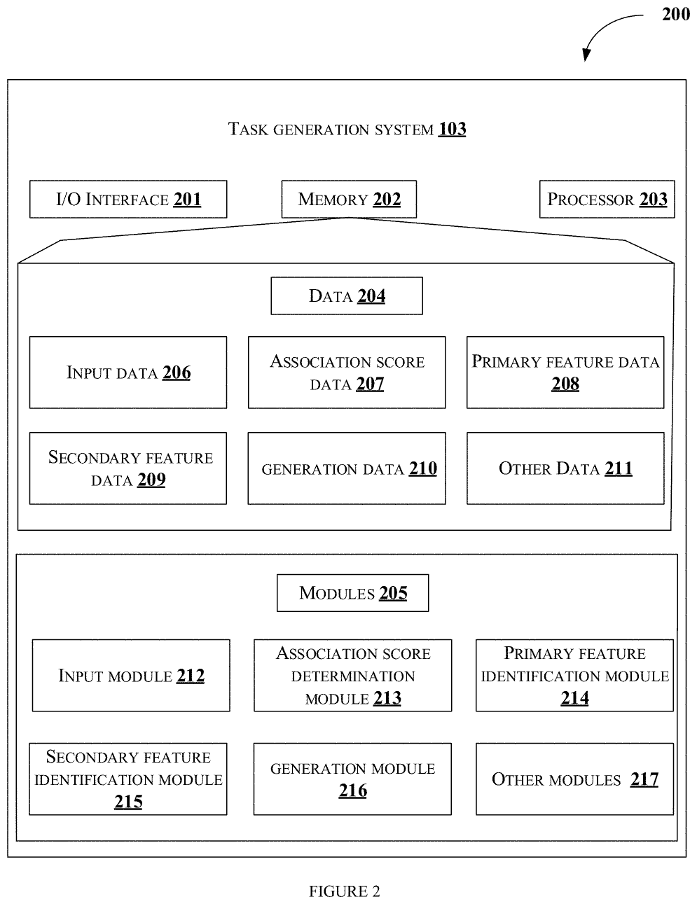

FIG. 2 illustrates a detailed diagram 200 of the task generation system 103 for generating the secondary tasks 104 for the neural network 102, in accordance with some embodiments of the present disclosure. The task generation system 103 may include an Input/Output (I/O) interface 201, a memory 202, and Central Processing Units 203 (also referred as “CPUs” or “one or more processors 203”). In some embodiments, the memory 202 may be communicatively coupled to the one or more processors 203. The memory 202 stores instructions executable by the one or more processors 203. The one or more processors 203 may comprise at least one data processor for executing program components and executing user or system-generated requests. The memory 202 may be communicatively coupled to the one or more processors 203. The memory 202 stores instructions, executable by the one or more processors 203, which, on execution, may cause the one or more processors 203 to generate the secondary tasks 104 for the neural network 102. In an embodiment, the memory 202 may include one or more modules 205 and data 204. The one or more modules 205 may be configured to perform the steps of the present disclosure using the data 204, to generate the secondary tasks 104 for the neural network 102. In an embodiment, each of the one or more modules 205 may be a hardware unit that are external to the memory 202 and coupled with the task generation system 103. As used herein, the term modules 205 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 205 when configured with the described functionality defined in the present disclosure will result in a novel hardware. Further, the I/O interface 201 is coupled with the one or more processors 203 through which an input signal or/and an output signal is communicated. For example, the generated one or more secondary tasks 104 may be provided to neural networks implemented in other systems. The task generation system 103 may transmit the one or more secondary tasks 104 via the I/O interface 201 to the other systems. In an embodiment, the task generation system 103 may be implemented in a variety of computing systems, such as a laptop computer, a desktop computer, a Personal Computer (PC), a notebook, a smartphone, a tablet, a server, a network server, a cloud-based server, and the like.

In one implementation, the modules 205 may include, for example, an input module 212, an association score determination module 213, a primary feature identification module 214, a secondary feature identification module 215, a generation module 216, and other modules 217. It will be appreciated that such aforementioned modules 205 may be represented as a single module or a combination of different modules. In one implementation, the data 204 may include, for example, input data 206, association score data 207, feature data 208, secondary feature data 209, generation data 210, and other data 211.

In an embodiment, the input module 212 may be configured to receive the feature set comprising the one or more features of each of the plurality of data items 101. The plurality of data items 101 comprises one of, images, videos, audio inputs, text inputs, speech inputs, and the like. The input module 212 may receive the feature set from the neural network 102. In an embodiment, the neural network 102 may be a trained neural network. The neural network 102 may be trained for the primary task. The neural network 102 may have the ability to extract the feature set when trained for the primary task. For example, the neural network 102 may be trained to identity male pedestrians and female pedestrians in video analytics. The neural network 102 may be trained to identity the male pedestrians and the female pedestrians by extracting the one or more features such as facial information, appearance information, and the like. In another embodiment, the neural network 102 may be an untrained neural network. In such case, a user may provide labels related to the primary task to the neural network 102 for training the untrained neural network. The neural network 102 may extract the feature set after training is performed. In another embodiment, the neural network 102 may be a trained neural network, which may not be trained for the primary task. In such scenario, the user may provide the labels related to the primary task for generating the feature set. In the above stated example, the plurality of data items 101 may be a plurality of input images comprising the male and female pedestrians. The one or more features and the plurality of data items 101 may be stored as the input data 206 in the memory 202. In an example, the one or more features may be stored as a feature matrix comprising rows of the one or more features, each row comprising the one or more features of each of the plurality of data items 101.

In an embodiment, the association score determination module 213 is configured to receive the feature set from the input module 212. The association score determination module 213 may be configured to determine an association score between each of the one or more features of a data item from the plurality of data items 101 with each of the one or more features of other data items from the plurality of data items 101. For example, the association score determination module 213 may determine the association score of a first feature of a first data item with each feature among the one or more features of a second data item. Similarly, the association score determination module 213 determines the association score of a second feature of a data item with each feature among the one or more features of a second data item. The association score indicates a correlation between the one or more features of each of the plurality of data items 101. The association score is determined to analyze associations or correlations between the one or more features to generate the secondary tasks 104 for the neural network 102. The association score is used to quantify the degree to which two features are related. The association score determination module 213 determines the association score based on equation (1) given as below:

$$Association score = \frac{{DD}^{T}}{σ ( D ) * σ ( D )} \qquad ( 1 )$$

where, D is of size m×n for ‘m’ number of data items each with feature vectors of size n.

The association score determination module 213 may determine the association scores between each of the one or more features of a data item from the plurality of data items 101 with each of the one or more features of other data items using one or more techniques. In an embodiment, the association score may include values ranging from 0-1. In one embodiment, the association score determination module 213 may use techniques such as, but not limited to, Pearson correlation, Kendall rank correlation, Spearman rank correlation, distance-based similarity estimation techniques (for example, Euclidean distance, cosine similarity, and the like), and the like to determine the association scores. In another embodiment, an artificial neural network may be used to determine the association scores. A person skilled in the art will appreciate that any known methods other than the above-mentioned methods may be used to determine the association scores between each of the one or more features of a data item with each of the one or more features of other data items. The association scores between each of the one or more features of a data item with each of the one or more features of other data items can be stored as the association score data 207 in the memory 202.

In an embodiment, the primary feature identification module 214 may be configured to receive the association score data 207 from the association score determination module 213. The primary feature identification module 214 is configured to identify a first set of features from the feature set. The first set of features is identified based on a comparison of the association score related to the one or more features of the plurality of data items 101 with a threshold value. The threshold value indicates a level of association or correlation between the one or more features. In an embodiment, the threshold value may be pre-defined. In another example, the threshold value may be set based on applications, types of data items, number of data items, and the like. For example, the threshold value may be 0.8 for a first application. In another example, the threshold value may be 0.5 for a second application. When the association score is greater than the threshold value, the one or more features are highly correlated or associated. The primary feature identification module 214 identifies the first set of features when the association score is greater than the threshold value. Further, the primary feature identification module 214 may be configured to identify a second set of features when the association score is below the threshold value. The second set of features may be less correlated or associated. In the present disclosure, further processing is performed on the second set of features to generate the one or more secondary tasks 104. The further processing is performed on the second set of features by the generation module 216 explained in paragraph 26. In an example, the threshold value may be set to a high value so that only highly correlated features may be used for generation of the one or more secondary tasks 104 directly. The second set of features having the association score below the threshold value can be refined to generate the one or more secondary tasks 104. Hence, the one or more secondary tasks 104 can be generated with higher accuracy through the correlation and further processing of the one or more features. The first set of features and the second set of features may be stored as the feature data 208 in the memory 202.

In an embodiment, the secondary feature identification module 215 may be configured to receive the feature data 208 from the primary feature identification module 214. The secondary feature identification module 215 is configured to identify the one or more secondary features by mapping the first set of features with the feature set. In an embodiment, the secondary feature identification module 215 may apply Reverse Singular Value Decomposition (R-SVD) on the first set of features based on equation (2) given as below:

Q=γλP_{n×k} (2)

where, Q is projection, P is random matrix sampled from one or more distributions, gamma ‘γ’ is an eigen matrix of P and lambda ‘λ’ is a square root of the eigen matrix.
Since the first set of features are determined from the feature set for the primary task, the first set of features are grouped or clustered according to the primary task. The reverse SVD segregates the first set of features from the primary task. The segregation helps to identify the one or more secondary features different from the one or more features related to the primary task. For example, the one or more secondary features may comprise a person hair style, person pose, and the like. A person skilled in the art will appreciate that other methods such as, low rank approximation, eigen decomposition spectral decomposition, and the like may be used to identify the one or more secondary features. The one or more secondary features may be stored as the secondary feature data 209 in the memory 202.

In an embodiment, the generation module 216 is configured to receive the secondary feature data 209 from the secondary feature identification module 215. The generation module 216 may be configured to generate one or more secondary task groups of the one or more secondary features. Since the reverse SVD maps the first set of features with the feature set, the first set of features with greater association score are segregated which helps to form the one or more secondary task groups of the one or more secondary features. The generation module 216 may use K-means clustering algorithm to generate the one or more secondary task groups of the one or more secondary features. A person skilled in the art will appreciate that any other known techniques such as spectral clustering, custom optimization-based grouping, and the like can be used to generate one or more secondary task groups of the one or more secondary features. Further, the generation module 216 is configured to label the one or more secondary task groups based on the feature set. For example, the feature set may comprise detecting a person based on facial information and detecting a person on a vehicle. A secondary task group may be generated for underage driving detection using the facial information and detecting the presence of the person on a vehicle. The secondary task group may be labelled based on the features comprising the facial information and the person using the vehicle. The one or more secondary tasks 104 are generated corresponding to the one or more secondary task groups. In the above-stated example, a secondary task may be the underage driving detection. The one or more secondary tasks 104 may be provided to one of, a trained neural network and an untrained neural network. For example, the trained neural network may be trained only for gender classification. The one or more secondary tasks 104 such as pose classification, hair style classification, and the like may be provided to the trained neural network, thereby scaling the neural network 102 for new tasks. In another example, the one or more secondary tasks 104 may be provided to the untrained neural network. Further, the generation module 216 may be configured to generate the one or more secondary tasks 104 based on the second set of features. In such case, the generation module 216 may select a set of ideal features from the second set of features, based on a predefined selection technique. For example, the predefined selection technique may be coreset identification. Coresets are defined as a small set of points that approximates the shape of a larger point set. The coreset identification identifies a set of ideal features by approximating the second set of features. A person skilled in the art will appreciate that techniques other than the above-mentioned technique may be used to select the set of ideal features from the second set of features. Further, the generation module 216 is configured to identify a first set of task groups of the set of ideal features, based on received inputs. The inputs may be received from one or more sources. For example, the one or more sources may comprise a user, a database comprising textual description that helps to identify the first set of task groups. Each task group from the first set of task groups comprises a plurality of ideal features from the set of ideal features. Since the second set of features are associated with low association scores, the inputs are received that help to identify the first set of task groups. Further, the generation module 216 is configured to select a second set of task groups comprising corresponding plurality of ideal features, based on the similarity between the plurality of ideal features of each of the first set of task groups. The received inputs may comprise the plurality of ideal features in form of groups or clusters. The generation module 216 may identify whether the plurality of ideal features is similar based on the groups or clusters. The generation module 216 may filter the second set of task groups from the first set of task groups based on the similarity. Further, the generation module 216 may label the second set of task groups with the corresponding plurality of ideal features to generate the one or more secondary tasks 104.

The other data 211 may store data, including temporary data and temporary files, generated by the one or more modules 205 for performing the various functions of the task generation system 103. The one or more modules 205 may also include the other modules 217 to perform various miscellaneous functionalities of the task generation system 103. The other data 211 may be stored in the memory 202. It will be appreciated that the one or more modules 205 may be represented as a single module or a combination of different modules.

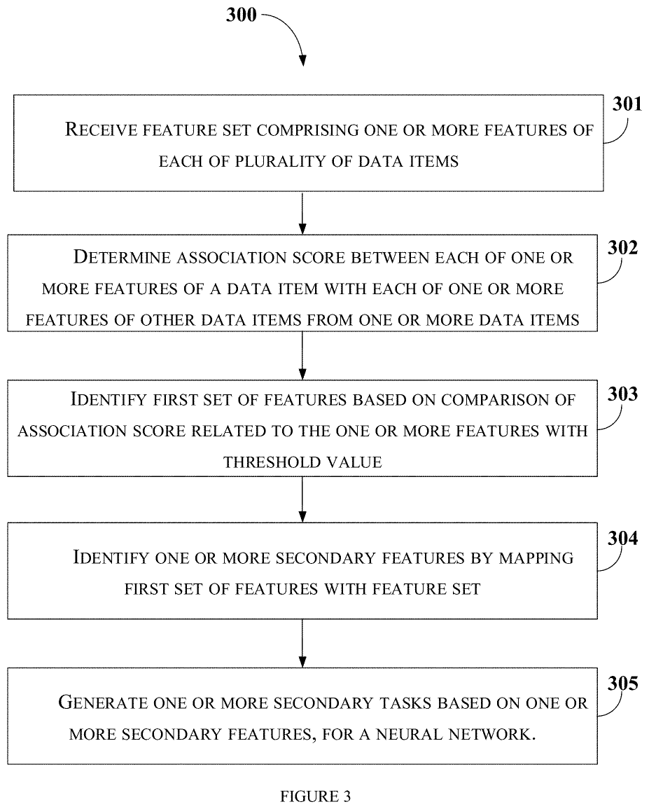

FIG. 3 shows an exemplary flow chart illustrating method steps for generating the secondary tasks 104 for the neural network 102, in accordance with some embodiments of the present disclosure. As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

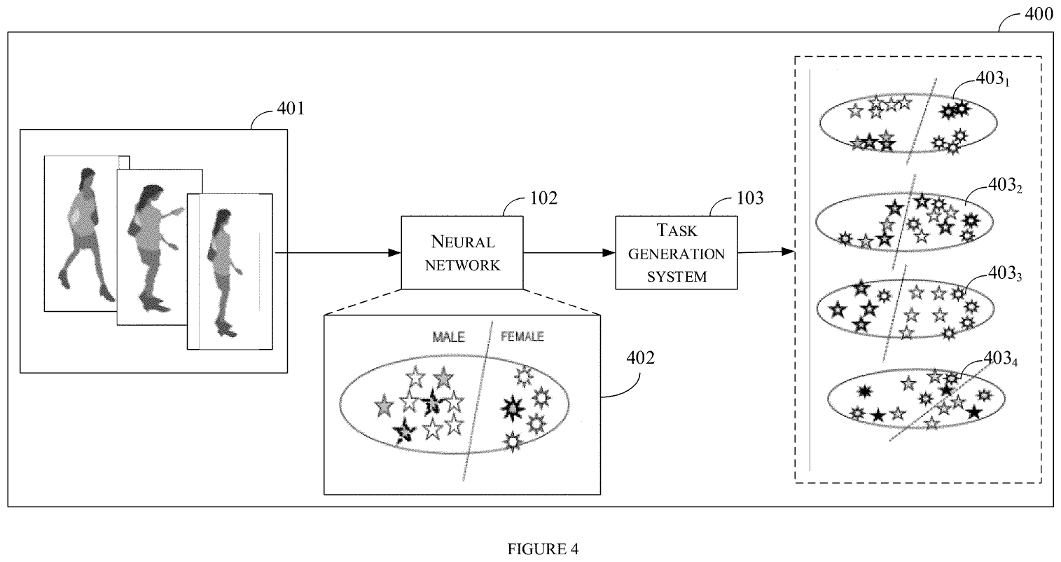

At step 301, the task generation system 103 receives the feature set comprising the one or more features of each of the plurality of data items 101. The task generation system 103 may receive the feature set from the neural network 102. In an embodiment, the neural network 102 may be a trained neural network, trained for the primary task. In another embodiment, the neural network 102 may be an untrained neural network. In another embodiment, the neural network 102 may be a trained neural network, which may not be trained for the primary task. Referring to FIG. 400 of FIG. 4A, the neural network 102 may be implemented in video analytics to monitor the pedestrians in a place. The plurality of data items 101 may comprise a plurality of input images 401 provided to the neural network 102 for extracting the feature set. The plurality of input images 401 comprises only three images of a female pedestrian, for illustrative purposes only. The plurality of input images 401 may comprise multiple images of female pedestrians and male pedestrians. The neural network 102 may extract the one or more features from each of the plurality of input images 401 and provide them to the task generation system 103.

Referring back to FIG. 3, at step 302, the task generation system 103 determines the association score between each of the one or more features of a data item from the plurality of data items 101 with each of the one or more features of other data items from the plurality of data items 101. The task generation system 103 may compute the correlation matrices comprising the association scores between each of the one or more features of a data item from the plurality of data items 101 with each of the one or more features of other data items. The association score determination module 213 may use known correlation techniques to determine the association scores. Referring again to the example 400 of FIG. 4A, a first image includes the female pedestrian wearing a white top and grey shorts. A second image may comprise a female pedestrian wearing a blue top and the grey shorts. A third image may comprise a male pedestrian wearing a white shirt and white shorts. The task generation system 103 may determine the association score between clothing feature of the first image, the second image, and the third image individually.

Referring back to FIG. 3, at step 303, the task generation system 103 identifies the first set of features from the feature set, based on a comparison of the association score related to the one or more features of the plurality of data items 101 with the threshold value. The task generation system 103 identifies the first set of features with the association score greater than the threshold value. Further, the task generation system 103 may be configured to identify a second set of features having the association score below the threshold value. The second set of features may be less correlated or associated. In the present disclosure, further processing is performed on the second set of features to generate the one or more secondary tasks 104. Referring to the above-stated example in relation to example 400 of FIG. 4A, the association score between the clothing feature of the first image and the second image may be high. Further, the association score between the clothing feature of the first image and the third image may be high. While the association score between the clothing feature of the second image and the third image may be low.

Referring back to FIG. 3, at step 304, the task generation system 103 identifies the one or more secondary features by mapping the first set of features with the feature set. In an embodiment, the task generation system 103 applies the reverse SVD on the first set of features. The reverse SVD segregates the first set of features in the feature set which are grouped according to the primary task. Referring again to the above-stated example in relation to example 400 of FIG. 4A, the clothing features of first image and the second image may be the one or more secondary features. The clothing features of first image and the third image may be the one or more secondary features.

Referring back to FIG. 3, at step 305, the task generation system 103 generates the one or more secondary tasks 104 based on the one or more secondary features, for the neural network 102. The task generation system 103 may be configured to generate the one or more secondary task groups of the one or more secondary features. Further, the task generation system 103 is configured to label the one or more secondary task groups based on the feature set. The one or more secondary tasks 104 are generated corresponding to the one or more secondary task groups. Referring again to the example 400 of FIG. 4A, the feature set related to the primary task is illustrated as 402. The primary task is gender classification. The task generation system 103 generates the one or more secondary tasks 4031, 4032, 4033, and 4034. The secondary task 4031 corresponds to classifying male and female pedestrians wearing grey shirts. Various clusters are formed such as the male and female pedestrians wearing the grey shirts and the male and female pedestrians wearing white shirts. The secondary task 4032 corresponds to classifying people wearing grey shirts and people wearing white shirts. Similarly, the secondary task 4033 corresponds to classifying people wearing blue (Represented as bold lines) shorts and people wearing black shorts. The secondary task 4033 corresponds to classifying people who are short and people who are tall.

The plurality of input images 401 is considered as an input to the neural network 102 in the above-stated example 400. This should not be considered as limiting. The embodiments of the present disclosure are equally applicable to the plurality of data items such as videos, audio inputs, text inputs, speech inputs, and the like. For example, the plurality of data items 101 may comprise textual documents when the neural network 102 is implemented in natural language processing. The primary task may be sentiment analysis. The task generation system 103 may generate the one or more secondary tasks 104 such as, named entity recognition, Part-of-Speech (PoS) tagging, polarity estimation, offensiveness classification, document class tagging, and the like. In another example, the plurality of data items 101 may comprise speech data when the neural network 102 is implemented in speech processing. The primary task may be English identification. The task generation system 103 may generate the one or more secondary tasks 104 such as speech translation, keyword identification, response generation, other language identification, non-native Automatic Speech Recognition (ASR), code mixed word identification, and the like.

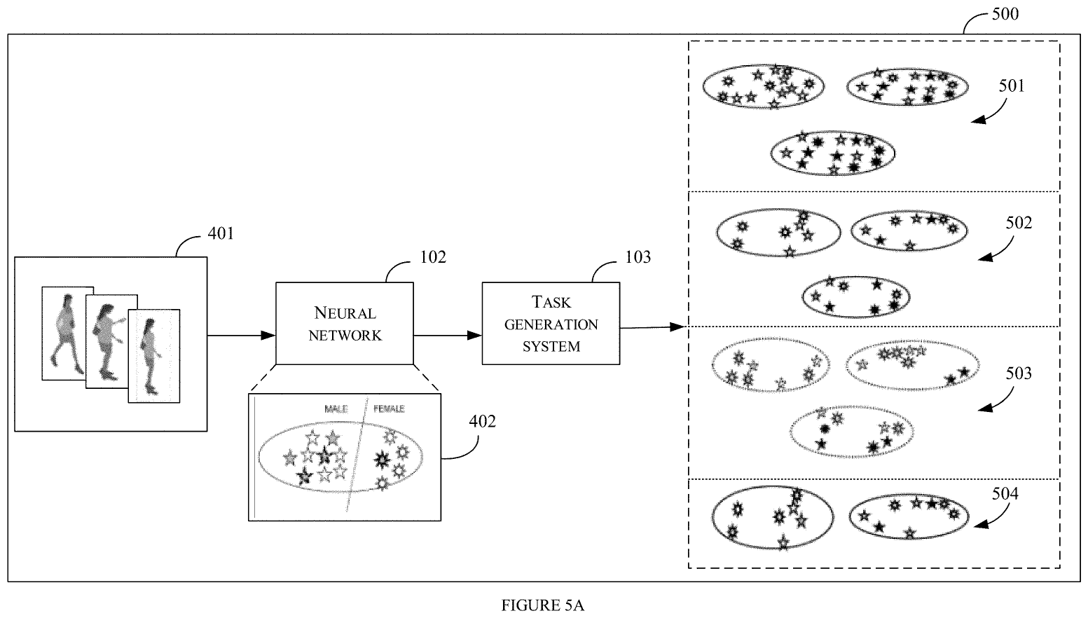

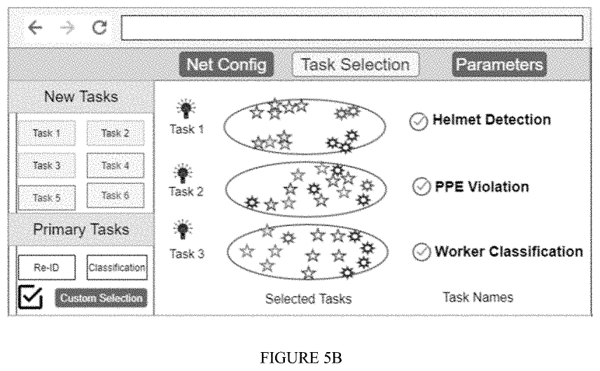

In an embodiment, the task generation system 103 may be configured to generate the one or more secondary tasks 104 based on the second set of features. An example 500 of FIG. 5A illustrates the second set of features 501. The task generation system 103 may select a set of ideal features 502 from the second set of features, based on the predefined selection technique. The task generation system 103 may not be able to identify groups or clusters from the set of ideal features, since the association score is below the threshold value, Hence, the task generation system 103 may receive the inputs from the one or more sources and identify a first set of task groups 503 of the set of ideal features, based on the received inputs. The task generation system 103 may select a second set of task groups 504 comprising the corresponding plurality of ideal features, based on the similarity between the plurality of ideal features of each of the first set of task groups. The second set of task groups with the corresponding plurality of ideal features are labelled to generate the one or more secondary tasks 104. FIG. 5B illustrates a user interface provided for generating the one or more secondary tasks 104. A neural network associated with for example, an enterprise, may be trained for primary tasks (task 1, task 2, and task 3). The task generation system 103 may generate the one or more secondary tasks (task 4, task 5, task 6, task 7). For example, the primary task (task 1) may be helmet detection. The secondary task (task 4) may be underage driving detection.

### Computer System

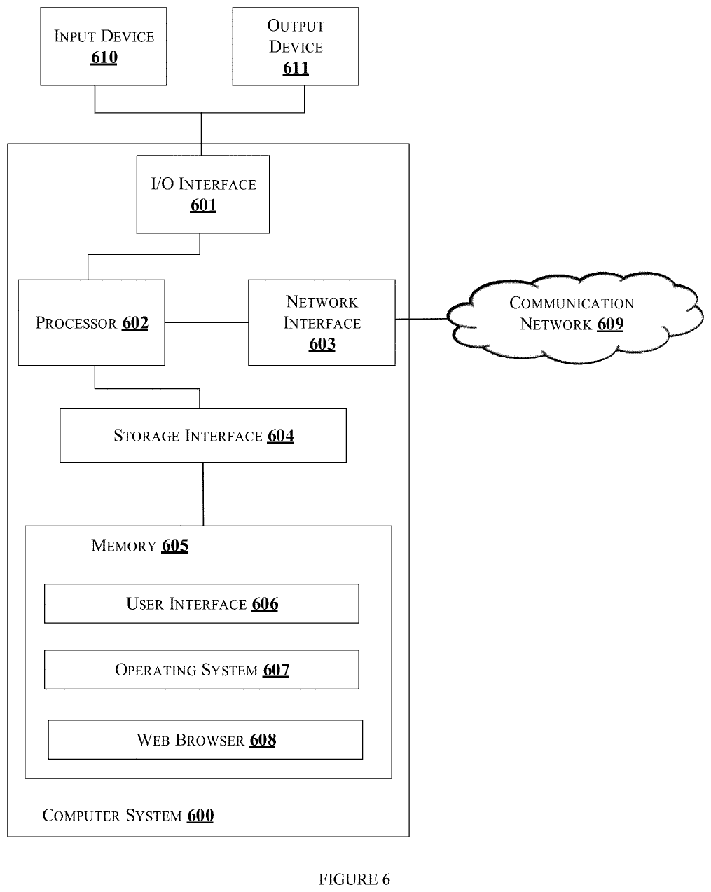

FIG. 6 illustrates a block diagram of an exemplary computer system 600 for implementing embodiments consistent with the present disclosure. In an embodiment, the computer system 600 may be the task generation system 103. Thus, the computer system 600 may be used to generate the one or more secondary tasks 104 for the neural network 102. The computer system 600 may receive the feature set from the neural network 102. Further, the computer system 600 may determine the association score between each of the one or more features, identify the first set of features, identify the one or more secondary features, and generate the one or more secondary tasks 104 for the neural network 102. The computer system 600 may comprise a Central Processing Unit 602 (also referred as “CPU” or “processor”). The processor 602 may comprise at least one data processor. The processor 602 may include specialized processing units such as integrated system (bus) controllers, memory management control units, floating point units, graphics processing units, digital signal processing units, etc.

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices. For example, the input device 610 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 611 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The computer system 600 may communicate with the one or more receivers 612 through the communication network 609. The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface 606, an operating system 607, web browser 608 etc. In some embodiments, computer system 600 may store user/application data, such as, the data, variables, records, etc., as described in this disclosure. Such databases may be implemented as fault-tolerant, relational, scalable, secure databases such as Oracle® or Sybase®.

The operating system 607 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™ VISTA™/7/8, 10 etc.), APPLE® IOS™, GOOGLE® ANDROID™, BLACKBERRY® OS, or the like.

In some embodiments, the computer system 600 may implement the web browser 608 stored program component. The web browser 608 may be a hypertext viewing application, for example MICROSOFT® INTERNET EXPLORER™, GOOGLER® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBE® FLASH™, JAVASCRIPT™, JAVA™, Application Programming Interfaces (APIs), etc. In some embodiments, the computer system 600 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™ PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure aids in generating multiple secondary tasks from the primary task for the neural network. The secondary tasks can be used for training an untrained neural network or for scaling a trained neural network for multiple new tasks. Hence, the neural network can be used to perform diverse tasks and can be scaled across multiple domains. The present disclosure identifies the new tasks by determining highly correlated features and provides refinement for less correlated features. The present disclosure helps to deploy the neural networks to new environments and problem domains without any retraining.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Referral number | Description |
|---|---|
| 100 | Exemplary environment |
| 101 | Plurality of data items |
| 102 | Neural network |
| 103 | Task generation system |
| 104 | One or more secondary tasks |
| 200 | Detailed diagram |
| 201 | I/o interface |
| 202 | Memory |
| 203 | Processor |
| 204 | Data |
| 205 | Modules |
| 206 | Input data |
| 207 | Association score data |
| 208 | Feature data |
| 209 | Secondary feature data |
| 210 | Generation data |
| 211 | Other data |
| 212 | Input module |
| 213 | Association score determination module |
| 214 | Primary feature identification module |
| 215 | Secondary feature identification module |
| 216 | Generation module |
| 217 | Other modules |
| 400 | Example |
| 401 | Plurality of input images |
| 402 | Feature set |
| 403₁, 403₂, 403₃, | One or more secondary tasks |
| and 403₄ | |
| 500 | Example |
| 501 | Second set of features |
| 502 | Set of ideal features |
| 503 | First set of task groups |
| 504 | Second set of task groups |
| 600 | Computer system |
| 601 | I/o interface |
| 602 | Processor |
| 603 | Network interface |
| 604 | Storage interface |
| 605 | Memory |
| 606 | User interface |
| 607 | Operating system |
| 608 | Web browser |
| 609 | Communication network |
| 610 | Input device |
| 611 | Output device |

We claim:

1. A method for generating secondary tasks for neural networks, the method comprising:
receiving, by a task generation system, a feature set comprising one or more features of each of a plurality of data items, wherein the one or more features are generated for a primary task;
determining, by the task generation system, an association score between each of the one or more features of a data item from the plurality of data items with each of the one or more features of other data items from the plurality of data items;
identifying, by the task generation system, a first set of features from the feature set, based on a comparison of the association score related to the one or more features of the plurality of data items with a threshold value, wherein the association score is greater than the threshold value for the first set of features;
identifying, by the task generation system, one or more secondary features by mapping the first set of features with the feature set; and
generating, by the task generation system, one or more secondary tasks (104) based on the one or more secondary features, for a neural network.

2. The method as claimed in claim 1, wherein generating the one or more secondary tasks comprises:
generating one or more secondary task groups of the one or more secondary features;
labelling the one or more secondary task groups based on the feature set; and
generating the one or more secondary tasks corresponding to the one or more secondary task groups.

3. The method as claimed in claim 1, further comprises identifying a second set of features having the association score below the threshold value.

4. The method as claimed in claim 3, further comprising generating one or more secondary tasks based on the second set of features by:
selecting a set of ideal features from the second set of features, based on a predefined selection technique;
selecting a second set of task groups comprising corresponding plurality of ideal features, based on a similarity between the plurality of ideal features of each of the first set of task groups; and
generating the one or more secondary tasks corresponding to the second set of task groups with the corresponding plurality of ideal features.

5. The method as claimed in claim 1, wherein the plurality of data items comprises one of, images, videos, audio inputs, text inputs, and speech inputs.

6. The method as claimed in claim 1, wherein the feature set is received from one of, a trained neural network and an untrained neural network.

7. The method as claimed in claim 1, wherein the neural network is one of, a trained neural network and an untrained neural network.

8. A task generation system for generating secondary tasks for neural networks, the task generation system comprising:
one or more processors;
a memory storing processor-executable instructions, which, on execution, cause the one or more processors to:
receive a feature set comprising one or more features of each of a plurality of data items, wherein the one or more features are generated for a primary task;
determine an association score between each of the one or more features of a data item from the plurality of data items with each of the one or more features of other data items from the plurality of data items;
identify a first set of features from the feature set, based on a comparison of the association score related to the one or more features of the plurality of data items with a threshold value, wherein the association score is greater than the threshold value for the first set of features;
identify one or more secondary features by mapping the first set of features with the feature set; and
generate one or more secondary tasks based on the one or more secondary features, for a neural network.

9. The task generation system as claimed in claim 8, wherein the one or more processors generate the one or more secondary tasks by:
generating one or more secondary task groups of the one or more secondary features;
labelling the one or more secondary task groups based on the feature set; and
generate the one or more secondary tasks corresponding to the one or more secondary task groups.

10. The task generation system as claimed in claim 8, wherein the one or more processors are further configured to identify a second set of features having the association score below the threshold value.

11. The task generation system as claimed in claim 10, wherein the one or more processors are further configured to generate the one or more secondary tasks based on the second set of features by:
selecting a set of ideal features from the second set of features, based on a predefined selection technique;
identifying a first set of task groups of the set of ideal features, based on received inputs, wherein each task group from the first set of task groups comprises a plurality of ideal features from the set of ideal features;
selecting a second set of task groups comprising corresponding plurality of ideal features, based on a similarity between the plurality of ideal features of each of the first set of task groups; and
generating the one or more secondary tasks corresponding to the second set of task groups with the corresponding plurality of ideal features.

12. The task generation system as claimed in claim 8, wherein the plurality of data items are one of, images, videos, audio inputs, text inputs, and speech inputs.

13. The task generation system as claimed in claim 8, wherein the one or more processors receive the feature set from one of, a trained neural network and an untrained neural network.

14. The task generation system as claimed in claim 8, wherein the neural network is one of, a trained neural network and an untrained neural network.
